(19) United States
(12) Patent Application Publication
(10) Pub. No.: US 2006/0262693 A1
(43) Pub. Date: Nov. 23, 2006

(54) Apparatus and method for writing multiple radial locations during a single rotation of a disk recording medium

(75) Inventors: Neil Deeman, Alamo, CA (US); David S. Kuo, Palo Alto, CA (US); Christopher J. Formato, Brentwood, CA (US); Sundeep Chauhan, Edina, MN (US); Lawrence M. Bryant, Palo Alto, CA (US)

Correspondence Address: SEAGATE TECHNOLOGY LLC;c/o MCDERMOTT WILL & EMERY LLP, 600 13TH STREET, NW, WASHINGTON, DC, 20005-3096, US

(73) Assignee: SEAGATE TECHNOLOGY LLC

(21) Appl. No.: 11/132,198

(22) Filed: May 19, 2005

(51) Int. Cl. G11B 7/0045

(52) U.S. Cl. 369/59.11

(57) ABSTRACT

An apparatus for and method of writing multiple radial locations during a single rotation by deflection and modulation of a recording beam, employs an electron beam with a width that is narrower than a radial width of the exposure pattern. Instead of employing multiple exposure passes, with each offset from the other by a certain radial distance, the apparatus performs the write of the pattern in a single pass. During this single pass, controlled by a single rotation of the turntable on which the disk recording medium is located, the electron beam is deflected in a radial direction by a required amount and modulated in synchronization with the radial deflection. This synchronization of the beam modulation with the beam deflection allows a plurality of tracks to be written or exposed in a single pass.

### FIELD OF THE INVENTION

The present invention relates to techniques and equipment for laying down track exposure patterns, for example, tracks of servo patterns to be formed on a surface of a magnetic disk of a hard disk drive, using an electron beam recorder or other beam recording device that produces such track exposure patterns.

### BACKGROUND OF THE INVENTION

A magnetic disk drive, such as a hard disk drive, stores data on one or more disks coated with a magnetic medium. For read/write purposes, the surface of the magnetic medium carries a number of generally parallel data tracks, which on a disk type medium, are arranged concentrically with one another about the center of the disk.

An actuator arm positions a transducer, or “head”, over a desired track, and the head writes data to the track or reads data from the track. As the disk rotates, the actuator arm moves the head in a radial direction across the data tracks under control of a closed-loop servo system, based on position information or “servo data”, which is stored within dedicated servo fields of the magnetic medium of the disk. The servo fields can be interleaved with data sectors on the disk surface or can be located on a separate disk surface that is dedicated to storing servo information. As the head passes over the servo fields, it generates a read back signal that identifies the location of the head relative to the center line of the desired track. Based on this location, the servo system moves the actuator arm to adjust the head's position so that it moves towards a position over the desired track and/or a desired location within the track of current interest.

One requirement in the manufacture of such a hard disk drive relates to the formation of the servo patterns on the magnetic disk, which must be in concentric circular patterns. Systems for forming the servo tracks on magnetic disks have used both stepped translation mechanisms with laser beams and continuous translation mechanisms with electron beams.

When an electron beam is used to write an exposure pattern that has a radial width that is significantly wider than the beam width, multiple exposure passes are needed, each offset from the other by a radial distance, to create the pattern. This has the disadvantage of requiring a relatively long time to write a single track, and consequently, an entire disk. For example, refer to the schematic depiction of the writing of track exposure patterns on a disk in FIG. 1. The disk 10 has a surface coated with photoresist upon which the track exposure patterns are formed. In this simplified example, the track exposure pattern 12 is a single track exposure pattern, that has a certain width W1. The electron beam, forming the recording beam, has a narrower width W2. In the illustrated example, the width W1 is twice the width of W2. Hence, multiple passes have to be made in order to completely write an entire track exposure pattern.

The exposure pattern 12 is written on the disk 10 of FIG. 1 by first exposing the disk surface to the recording beam of the electron beam in a first pass 14, having a width of W2. A second pass 16 is made after a radial offsetting of the beam to the first pass 14. The two passes, 14, 16, in which the recording beam is modulated forms the entire track exposure pattern 12.

FIG. 2 depicts an exemplary flow chart of the write process in accordance with the above-described example. After starting the process, in step S10, the recording beam apparatus is employed to make a first exposure pass, such as exposure pass 14 in FIG. 1, which forms one part of the exposure pattern of the entire track exposure pattern 12. In step S12, the recording beam is offset a radial distance and another exposure pass is made in step S14. This creates the second pass 16 forming another part of the entire track exposure pattern 12 on the disk 10.

In step S16, it is determined whether the entire track exposure pattern 12 has been written. In the example given above, only two passes are needed to completely write the entire track exposure pattern 12. However, it is possible that additional passes are needed to write a single track exposure pattern. In such cases, (“No”), the process loops back to step S12 and additional offsets and exposures are performed to write the entire track.

In step S18, it is determined, after an entire track exposure pattern has been written, whether this is the last track exposure pattern that should be written on the disk 10. If it is determined that the last track written is not the last track to be written on the disk 10, i.e., additional tracks need to be written, in step S20 the beam is offset a radial distance so that a new track exposure pattern may be formed.

As stated earlier, the problem with such a methodology, normally required by systems in which the radial width of the exposure pattern is significantly wider than that of the beam width, is the relatively long time required to write a single track exposure pattern using the multiple exposure passes.

### SUMMARY OF THE INVENTION

There is a need for a method that reduces the time required to write track exposure patterns on a disk recording medium.

This and other needs are meet by embodiments of the present invention which provide a method of writing patterns on a disk recording medium, comprising the steps of rotating the disk recording medium a single rotation only, radially deflecting a recording beam across a first set of multiple tracks during the single rotation of the disk recording medium, and modulating the recording beam during the single rotation of the disk recording medium and the radial deflection of the recording beam. These steps thereby form a set of multiple exposure track patterns on the disk recording medium during the single rotation of the disk recording medium.

By the radial deflection of the recording beam across a set of multiple tracks, and modulating this recording beam during the radial deflection, a set of multiple track exposure patterns can be formed on the disk recording medium during a single rotation. This provides a significant reduction in the amount of time needed to record a pattern, since several tracks may be written in a single pass.

The earlier stated needs are met by other embodiments of the present invention which provide an electron beam recording system for forming exposure patterns on disk recording medium. The system comprises an electron beam column for generating a modulated electron beam. The electron beam column includes deflection plates for controlling deflection of the electron beam in response to a deflection signal, and blanking plates for modulating the electron beam in response to a modulation signal. A turntable is provided for rotating the disk recording medium while applying the electron beam to a surface of the disk recording medium. A signal generator is provided for supplying the deflection signal to the deflection plates and the modulation signal to the blanking plates. The electron beam has a beam width narrower than a width of a single track exposure pattern. The signal generator supplies the deflection signal such that the electron beam is radially deflected to write the entire track exposure pattern during a single rotation of the disk recording medium.

The earlier stated needs are also met by other embodiments of the present invention which provide a recording system for recording patterns in a disk recording medium. The system comprises a turntable on which the disk recording medium is rotated, and means for writing multiple radial locations on the disk recording medium during a single rotation of the turntable.

The foregoing and other features, advantages and aspects of the present invention will become more apparent from the following detailed description of the present invention when taken in conjunction with the accompanying drawings.

### BRIEF DESCRIPTION OF THE DRAWINGS

FIG. 1 is a top plan view of a disk recording medium showing the formation of a single track exposure pattern written in multiple passes of a recording beam in accordance with prior art methodologies.

FIG. 2 is a flow chart of a method of recording a track exposure pattern depicted in FIG. 1.

FIG. 3 is a side view of an electron beam disk recording system for forming patterns on a disk recording medium, constructed in accordance with embodiments of the present invention, with elements of the electron beam device shown in cross-section.

FIG. 4 is a block diagram of a signal flow useful in explaining the control of the electron beam column and the turntable on the electron beam recording system of FIG. 3.

FIG. 5 is a top plan view of a disk showing formation of multiple track exposure patterns in accordance with embodiments of the present invention.

FIG. 6 is a flow chart of a method of writing multiple track exposure patterns in a single pass in accordance with embodiments of the present invention.

FIG. 7 is a graph showing exemplary deflection and modulation signals in accordance with embodiments of the present invention.

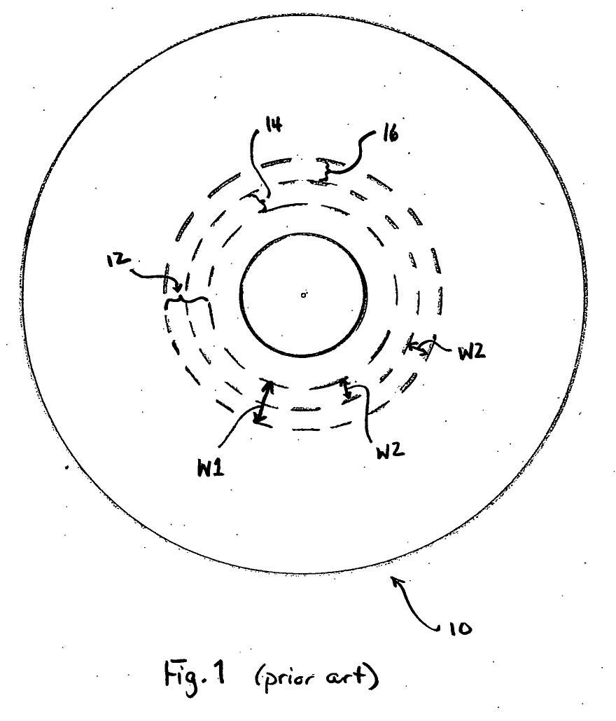

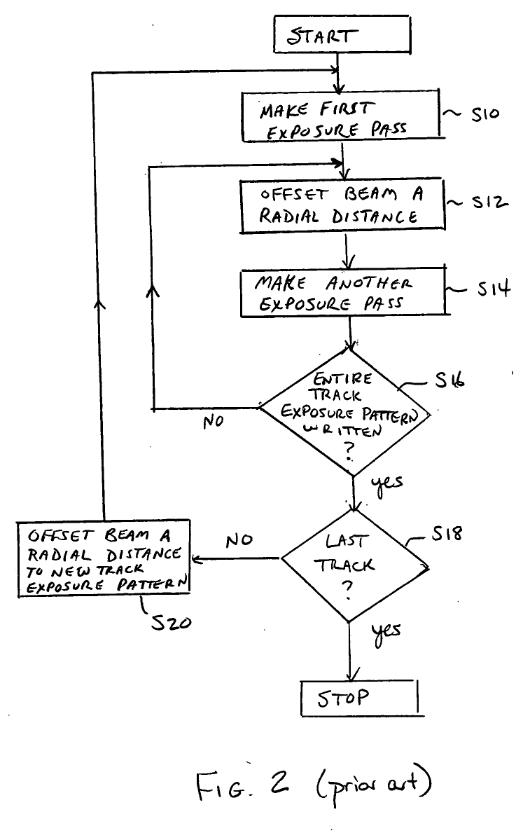

### DETAILED DESCRIPTION OF THE INVENTION

The concepts disclosed herein address and solve problems related to writing track exposure patterns that are wider than the width of a recording beam used to write the track exposure patterns. These and other problems are solved, in part, by performing a single rotation of a turntable on which a disk recording medium is mounted, and modulating a beam synchronously with radial deflection of the recording beam. In this manner, multiple tracks can be exposed with a single pass of the electron beam over the track. This significantly reduces the amount of time needed to record a pattern by writing several tracks per pass.

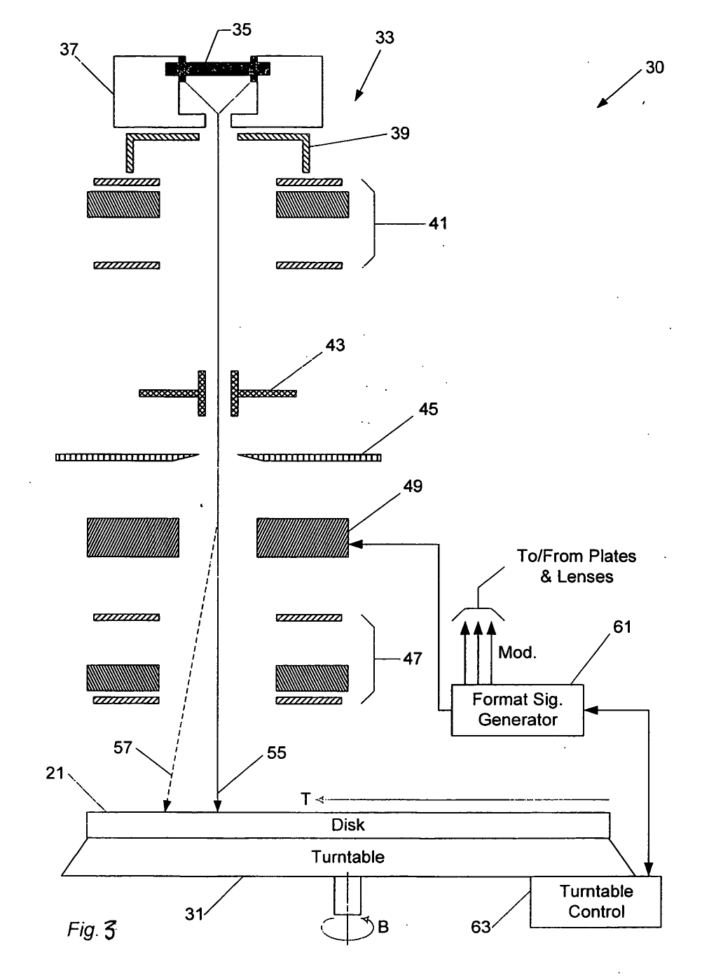

FIG. 3 depicts an exemplary electron beam recording system 30. The system 30 includes a turntable 31 and an electron beam column 33 for generating and manipulating the recording beam. The turntable 31 supports a disk 21 for rotation in the direction B about its vertical axis, and for lateral translation in the direction T, beneath the beam emitted by the column 33.

In the embodiment of the invention depicted in FIG. 3, the electron beam column 33 includes a thermal field emission (TFE) electron source 35 and a suppression assembly 37. The column may also include electron extractor 39. When appropriate voltages are applied to the TFE source 35, the suppression assembly 37 and the extractor 39, these elements cooperate to generate a stream of electrons for further processing in the column 33. The stream of electrons passes through a first triple element lens 41, then through blanking plates 43 and a blanking aperture 45. This stream of electrons then passes through one or more additional lenses, represented for example, by the second triple lens 47 in the drawing.

The shapes of and voltages applied to the column elements serve to focus and shape the stream of electrons into an electron beam of a desired shape and having a desired energy level for a particular application, for example, for forming servo patterns of particular size and depth in the surface of the disk 21. The drawing in FIG. 3 shows the beam traveling through the column 33 as a straight line, for convenience of illustration. In actual operation, the beam would converge and diverge as it passes through the various elements of the column 33, in order to focus on the sample on the turntable 31 in a desired manner.

Of note for purposes of the present subject matter, the beam position is controlled by application of a voltage to the deflection plates 49 in accordance with embodiments of the present invention. Without deflection, for example, at the start of a disk rotation, the beam travels in a perpendicular fashion as shown in 55, from the E-beam column 33 to the resist surface on the disk 21. Applying a deflection voltage to the plates 49 causes deflection of the beam. The polarity of the voltage determines the direction of the deflection. The amplitude of the voltage controls the magnitude of angular deflection of the beam and thus the linear displacement of the beam at a given distance from the column, for example, at the distance to the resist layer on the surface of the disk 21. A deflected beam output is represented by the dotted line 57 in FIG. 3. Typically, the angle and thus the linear displacement are proportional to the voltage applied across the plates 49. A DC voltage will produce a constant deflection, and a variable voltage produces a proportionally varying angle of deflection of the beam.

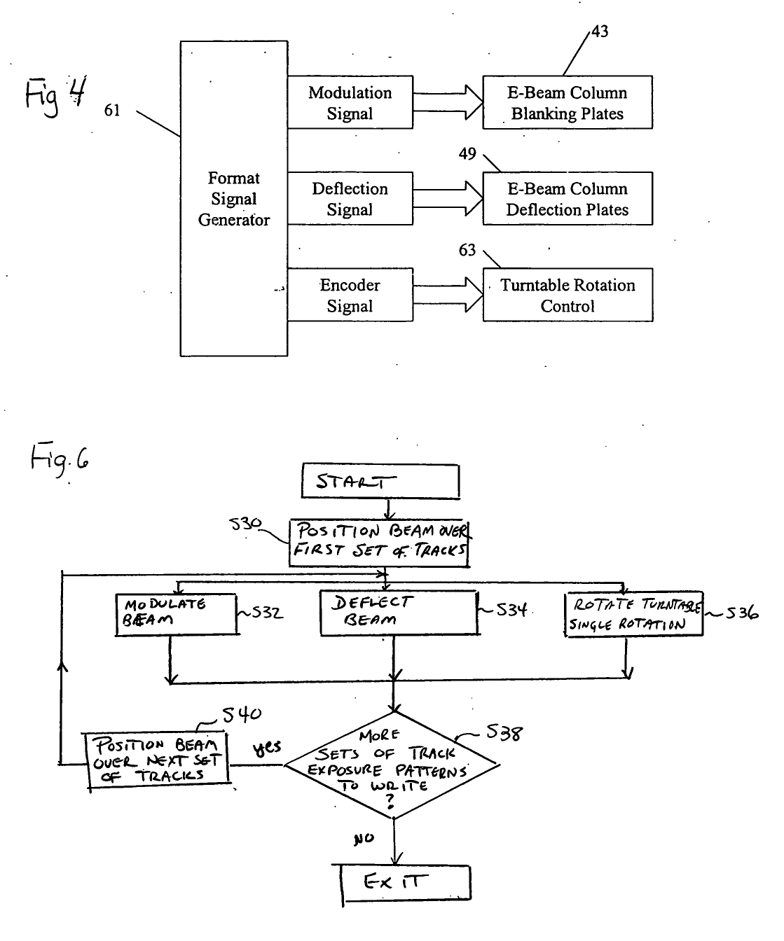

The electron beam recording system 30 includes a format signal generator 61, for generating various signals used by the electron beam column 33 to modulate the beam and format the patterns being exposed on the disk 21. The format signal generator 61 essentially comprises circuitry forming one or more signal generators, for producing the various signals applied to the components of the electron beam recording system 30 to produce the desired beam. FIG. 4 is a signal flow diagram illustrating some aspects of the function of the format signal generator 61.

As shown in FIGS. 3 and 4, one example of a signal produced by the format signal generator 61 is the format modulation signal (or “beam format” signal) for application to the blanking plates 43, which controls the energy level of the electron beam and thus the exposure of the recorded pattern. A control 63 controls the rotational speed and possibly the translational movement of the turntable 31. The format signal generator 61 provides an encoder signal to the turntable control 63, to regulate the rotational operations of the turntable 31, and the control 63 may provide one or more feedback signals to the generator 61 indicating turntable position and/or speeds. For example, the turntable control 63 may provide an index signal each time a mark or feature on the turntable or disk passes a reference point. The angle between rotation start point (e.g., 12 o'clock) and the reference point is a known constant. Hence, the index can be used to determine start and end points of successive rotations. The format signal generator 61 also provides the voltage to the deflection plates 49. As will be made clear, the present invention combines the use of a modulation signal and the deflection signal to write multiple radial locations in a single pass.

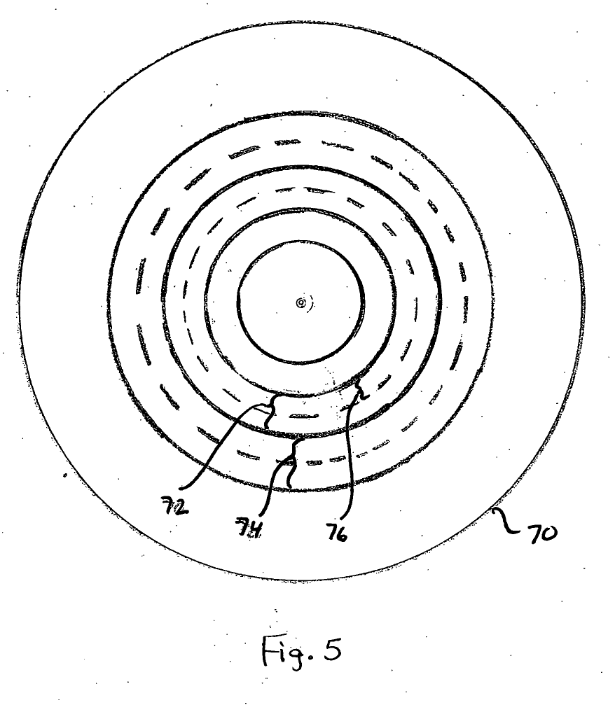

FIG. 5 depicts a disk recording medium 70 on which multiple tracks are written in a single pass in accordance with embodiments of the present invention. These tracks have a width that is greater than the width of the recording beam produced by the electron beam recorder of FIG. 3. In prior art methodologies, the narrower beam width required multiple exposure passes to write an exposure pattern having a radial width that was significantly wider than the beam width. In accordance with the invention, the format signal generator 61 controls the modulation and deflection signals to write multiple tracks in a single pass.

In FIG. 5, the disk 70 is shown as having a disk recording medium in which a first track 72 and a second track 74 are shown at different radial locations on the disk recording medium 70. These tracks 72, 74 may also be referred to as track exposure patterns. A single beam width is indicated by reference numeral 76. As can be readily ascertained from FIG. 5, the width of the beam 76 is significantly narrower than the width of a single track exposure pattern 72.

In the present invention, the format signal generator 61 provides for a controlled modulation signal and the deflection signal to write both of the track exposure patterns 72, 74 in a single rotation of the disk recording medium 70 by the turntable 31. The turntable rotational control 63 works with the format signal generator 61 to form a single rotation of a disk during the formatting of the multiple exposure track patterns 72, 74. It should be noted that only two track exposure patterns 72, 74 are depicted in FIG. 5, although the present invention is not limited to forming only two patterns during a single pass, but may be extended to form more than two track exposure patterns during a single pass or rotation of the turntable 31.

FIG. 7 depicts an exemplary representation of a modulation signal 80 and a deflection signal 82 as a function of time, to show the relationship between the signals 80, 82. As apparent from FIG. 7, the modulation signal 80 and the deflection signal 82 are simultaneously applied in certain embodiments to achieve the desired writing of multiple track exposure patters. It should be recognized that the depicted forms of the specific signals 80, 82 are exemplary only.

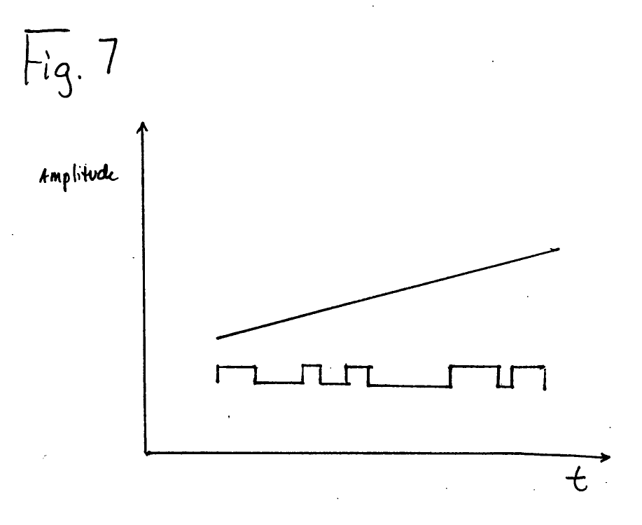

FIG. 6 is a flow chart depicting an embodiment of the method of the present invention to write multiple track exposure patterns in a single pass. Following the starting of the procedure, in step S30 the beam is positioned over a first set of tracks to be written. Following this, the turntable rotation control 63 causes the turntable 31 to be rotated by a single rotation only. At the same time, the format signal generator 61 deflects the beam radially a required amount to expose the first and second track exposure patterns 72, 74. This is depicted in step S34. The rotation of the turntable is depicted in step S36.

The beam is modulated in step S32 in synchronization with the deflection of the beam in step S34. The combination of beam modulation and synchronization with beam deflection allows a multiple of tracks (or track exposure patterns) to be written or exposed in a single pass of the disk recording medium 21. This methodology significantly reduces the amount of time needed to record a pattern by writing several tracks per pass. However, only two tracks 72, 74 are depicted in FIG. 5 for ease of explanation. The speed of the deflection of the beam and the rotation speed and the number of deflection cycles needed to correctly expose the marks will determine how much improvement is gained in the recording time.

After the disk recording medium 21 has been rotated a single rotation, and the first and second track exposure patterns 72, 74 written in their entirety employing the radial deflection of the recording beam and synchronous modulation of the recording beam, it is then determined whether any more sets of multiple track exposure patterns need to be written, in step S38. If there are more sets of multiple track exposure patterns to be written, the recording beam is positioned over the next set of tracks, in step S40. Otherwise, the process ends as the disk recording medium 70 has been completely written with the desired amount of track exposure patterns.

The beam recording column 33, along with the format signal generator 61 and turntable rotational control 63, may be considered to form means for writing multiple radial locations on the disk recording medium during a single rotation of the turntable. This means for writing also include means for modulating the electron recording beam and means for radially deflecting the electron recording beam. Further, the means for modulating and the means for radially deflecting include the format signal generator, blanking plates controlled by a modulation signal generated by the format signal generator, and deflection plates controlled by a deflection signal generated by the format signal generator.

The present invention thus provides for improved production speed for creating disk recording media in an efficient and rapid manner.

Although the present invention has been described and illustrated in detail, it is to be clearly understood that the same is by way of illustration and example only and is not to be taken by way of limitation, the scope of the present invention being limited only by the terms of the appended claims.

What is claimed is:

1. A method of writing patterns on a disk recording medium, comprising the steps:
(a) rotating the disk recording medium a single rotation only;
(b) radially deflecting a recording beam across a set of multiple tracks during the single rotation of the disk recording medium; and
(c) modulating the recording beam during the single rotation of the disk recording medium and the radial deflection of the recording beam, to thereby form a set of multiple track exposure patterns on the disk recording medium during the single rotation.

2. The method of claim 1, further comprising moving the radial position of the recording beam relative to the disk recording medium after the single rotation, and repeating steps (a)-(c) to thereby form another set of multiple track exposure patterns on the disk recording medium during another single rotation of the disk recording medium.

3. The method of claim 2 wherein the modulating of the recording beam is synchronous with the radially deflecting of the recording beam.

4. The method of claim 1, wherein the modulating of the recording beam is synchronous with the radially deflecting of the recording beam.

5. The method of claim 1, wherein the recording beam is an electron recording beam.

6. The method of claim 1, wherein the number of track exposure patterns formed during the single rotation of the disk is greater than two.

7. The method of claim 1, wherein the recording beam has a first width, and at least one of the track exposure patterns has a second width greater than the first width.

8. An electron beam recording system for forming exposure patterns on a disk recording medium, comprising:
an electron beam column for generating a modulated electron beam, the electron beam column including deflection plates for controlling deflection of the electron beam in response to a deflection signal, and blanking plates for modulating the electron beam in response to a modulating signal;
a turntable for rotating the disk recording medium while applying the electron beam to a surface of the disk; and
a signal generator for supplying the deflection signal to the deflection plates and the modulation signal to the blanking plates,
wherein the electron beam has a beam width narrower than a width of a single track exposure pattern, and the signal generator supplies the deflection signal such that the electron beam is radially deflected to write the entire track exposure pattern during a single rotation of the disk recording medium.

9. The system of claim 8, wherein the signal generator supplies the modulation signal synchronously with the radial deflecting of the electron beam.

10. The system of claim 9, wherein the signal generator supplies the deflection signal and the modulation signal such that the electron beam is radially deflected and modulated to write a set of multiple entire track exposure patterns during the single rotation of the disk recording medium.

11. The system of claim 10, wherein the number of track exposure patterns written during the single rotation of the disk recording medium is greater than two.

12. The system of claim 11, further comprising a turntable rotation controller for controlling rotation of the turntable in response to an encoder signal, wherein the signal generator supplies the encoder signal to cause the turntable rotation controller to rotate the disk recording medium by only the single rotation during the writing of the set of multiple entire track exposure patterns.

13. The system of claim 12, further comprising re-positioning the turntable relative to the electron beam column after the set of multiple entire track exposure patterns are written, and subsequently writing another set of multiple entire track exposure patterns on the disk recording medium radially offset from the previously written set of multiple entire track exposure patterns.

14. A recording system for recording patterns on a disk recording medium, comprising:
a turntable on which the disk recording medium is rotated; and
means for writing multiple radial locations on the disk recording medium during a single rotation of the turntable.

15. The system of claim 14, wherein the means for writing includes an electron beam column for generating an electron recording beam.

16. The system of claim 15, wherein the means for writing includes means for modulating the electron recording beam and means for radially deflecting the electron recording beam.

17. The system of claim 16, wherein the means for modulating and the means for radially deflecting are synchronized such that the multiple radial locations are written to form a plurality of track exposure patterns during the single rotation of the turntable.

18. The system of claim 17, wherein the electron recording beam has a width that is narrower than every individual track exposure pattern.

19. The system of claim 18, wherein the means for modulating and the means for radially deflecting comprises a format signal generator, blanking plates controlled by a modulation signal generated by the format signal generator, and deflection plates controlled by a modulation signal generated by the format signal generator, and deflection plates controlled by a deflection signal generated by the format signal generator.
